(19) United States
(12) Patent Application Publication
(10) Pub. No.: US 2024/0368391 A1
(43) Pub. Date: Nov. 7, 2024

(54) COATING COMPOSIONS WITH (STYRENE) ACRYLIC AND RUBBER

(71) Applicant: BASF SE, Ludwigshafen am Rhein (DE)

(72) Inventors: Xin LI, Charlotte, NC (US); Nicolas A. FOLEY, Charlotte, NC (US)

(21) Appl. No.: 18/573,469

(22) PCT Filed: Jun. 24, 2022
(86) PCT No.: PCT/US2022/034966

§ 371 Date: Dec. 22, 2023

Related U.S. Application Data
(60) Provisional application No. 63/214,998, filed on Jun. 25, 2021.

(51) Int. Cl. C08L 25/14; C09D 125/14

(52) U.S. Cl. CPC C08L 25/14; C09D 125/14

(57) ABSTRACT

Disclosed herein are coating compositions comprising latex polymer blends with enhanced properties, such as low tackiness and good film strength. Specifically, disclosed herein are latex polymer blends comprising styrene/acrylic latex or acrylic latex and rubber polymers.

### FIELD OF THE INVENTION

The present disclosure relates generally to latex polymer blends, as well as coating compositions and films containing latex polymer blends. Specifically, the compositions show high fracture resistance with a low tack surface. The compositions of the invention are suitable for latex paints and removable coatings.

### BACKGROUND OF THE INVENTION

Paints and coatings based on emulsion polymers, generally referred to as “latex” paints or coatings, are well known and widely used in a variety of applications. In particular, latex paints have captured a significant portion of the indoor and outdoor paint market, primarily because of their significant advantages over organic solvent-based paints. For example, latex paints offer easier cleanup than solvent-based paints. Latex paints also provide for reduced levels of volatile organic solvents as compared to solvent-based paints.

In spite of their many advantages, it may be difficult to formulate latex paints with good dry film flexibility and low tackiness. Low tackiness may be achieved by either raising the glass transition temperature (Tg) of the latex polymer or increasing the degree of crosslinking of the latex polymer. However, these approaches result in a reduced flexibility and may make the polymer film brittle.

Thus, there is a continuing need for aqueous polymer dispersions such as latex polymers which can provide coatings or films having excellent performance properties, such as good film flexibility, low brittleness, and low tackiness.

### SUMMARY OF THE DISCLOSURE

Disclosed herein are latex polymer blends, as well as coating compositions and films containing latex polymer blends. In particular, provided herein is a latex blend comprising at least one at least one styrene/acrylic latex or acrylic latex selected from the group consisting of pure acrylics, styrene acrylics, vinyl acrylics, acrylated ethylene vinyl acetate copolymers, and mixtures thereof:
at least one rubber latex,
wherein the solid mass ratio of the styrene/acrylic latex or acrylic latex to the rubber latex is between 90:10 and 10:90.

### DESCRIPTION OF THE DRAWINGS

FIG. 1 is a graph of tensile strain versus tensile stress for a styrene acrylic dry film, as described in Example 2.

FIG. 2 is a graph of tensile strain versus tensile stress for a styrene acrylic dry film blended with rubber latex, as described in Example 2.

FIG. 3 is an atomic force microscope (AFM) image of a dry film as described in Example 3.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” or “derived from” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The latex blends disclosed herein may include at least one styrene/acrylic latex or pure acrylic latex and at least one rubber latex. The styrene acrylic latex or pure acrylic latex disclosed herein may further include at least one crosslinkable monomer. The latex blends disclosed herein may further include additives, such as pigments, fillers, dispersants, coalescents, pH modifying agents, plasticizers, defoamers, surfactants, thickeners, biocides, co-solvents, and combinations thereof.

### Styrene/Acrylic Copolymers and Acrylic Polymers

The at least one styrene/acrylic latex or acrylic latex may include a plurality of polymer particles. The particles can have a particle size distribution range, as determined by static light scattering, dynamic light scattering, capillary hydrodynamic fractionation or microscope image analysis. For example, the methods described in ASTM E3247-20 and reported as volume average particle size, no greater than 5,000 nm, no greater than 4,000 nm, no greater than 3,000 nm, no greater than 2,000 nm, no greater than 1.000 nm, no greater than 750 nm, no greater than 500 nm, no greater than 400 nm, no greater than 300 nm, no greater than 200 nm, or no greater than 100 nm. In some embodiments, the particles have a particle size from 10-5,000 nm, from 10-4,000 nm, from 10-3,000 nm, from 10-2,000 nm, from 10-1,000 nm, from 10-750 nm, from 10-500 nm, from 10-400 nm, from 10-300 nm, from 10-200 nm, from 10-100 nm, from 10-50 nm, from 50-5,000 nm, from 50-4,000 nm, from 50-3,000 nm, from 50-2,000 nm, from 50-1,000 nm, from 50-750 nm, from 50-500 nm, from 50-400 nm, from 50-300 nm, from 50-200 nm, from 50-100 nm, from 100-1,000 nm, from 100-750 nm, from 100-500 nm, from 100-400 nm, from 100-300 nm, or from 100-200 nm.

In some embodiments, the particles have a particle size from 20-400 nm. In some embodiments, the particles have a particle size from 30-300 nm.

The particles can be prepared by polymerizing a monomer mixture emulsified in water, for instance by emulsion polymerization, optionally in the presence of a polymeric seed. In some embodiments, the particles can include at least two different copolymers (a multi-stage copolymer), e.g., a styrene/acrylic copolymer, an acrylic polymer, a second copolymer, a third copolymer, etc. In some embodiments, the styrene/acrylic copolymer polymer or acrylic polymer, second copolymer, etc. can be prepared in separate reaction vessels, and then combined. In preferred embodiments, the second copolymer, third copolymer, etc. is prepared by polymerizing a monomer mixture in the presence of the styrene/acrylic copolymer or the acrylic polymer.

As used herein, the term “homopolymer” refers to a polymer formed from one species of monomer.

As used herein, the term “copolymer” refers to a polymer formed from two or more species of monomer.

As used herein, the term “(meth)acrylate monomer” includes acrylate, methacrylate, diacrylate, and dimethacrylate monomers.

As used herein, the term “rubber latex” may be used interchangeable with the term “rubber polymer”.

As used herein, the term “theoretical glass transition temperature” or “theoretical Tg” refers to the estimated Tg of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$1 / {T}_{g} = wa / {T}_{ga} + wb / {T}_{gb} + … + wi / {T}_{gi}$$

where wa is the weight fraction of monomer a in the copolymer, T_{ga} is the glass transition temperature of a homopolymer of monomer a, wb is the weight fraction of monomer b in the copolymer, T_{gb} is the glass transition temperature of a homopolymer of monomer b, wi is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

Provided herein are latex polymer blends comprising at least one styrene/acrylic latex or acrylic latex, and at least one rubber latex.

The styrene/acrylic copolymers and acrylic polymers may be derived from at least one monomer selected from the group consisting of styrene, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid, and vinylphosphonic acid.

The styrene/acrylic latex or acrylic latex may further include a crosslinkable monomers such as diacetone acrylamide and its derivatives, and 2-(methacryloyloxy)ethyl acetoacetate and its derivatives.

Preferably, the styrene/acrylic latex or acrylic may be derived from at least one monomer selected from styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid, diacetone acrylamide and 2-(methacryloyloxy)ethyl acetoacetate.

The styrene/acrylic latex or acrylic latex may further include a crosslinking agent that can react with the crosslinkable monomers described above. The crosslinking agent may include adipic dihydrazide (ADDH); multifunctional amines; and metal ions, such as copper, magnesium, zinc, calcium, iron, chromium, titanium, aluminum, and zirconium, for example. Preferrably, the metal ions are zinc, aluminum or zirconium.

In some embodiments, the glass transition temperature (Tg) of the styrene/acrylic latex or acrylic latex can range from −60° C. to 30° C. For example, the Tg may be −40° C. or greater, −35° C. or greater, −30° C. or greater, −25° C. or greater, −20° C. or greater, −15° C. or greater, −10° C. or less, −5° C. or less, 0° C. or less, 5° C. or less, or 10° C. or less. The glass transition temperature can be determined by differential scanning calorimetry (DSC) by measuring the midpoint temperature using ASTM D 3418-12e1.

The Tg of the styrene/acrylic latex or acrylic latex can be between any of the values described above. For example, the Tg can range from −60° C. to 30° C. (e.g., from 0° C. to 5° C., from 0° C. to 5° C., from −10° C. to −30° C., or from −20° C. to −40° C., for example).

The styrene/acrylic latex or acrylic latex may include a soft phase. The glass transition temperature (Tg) of the soft phase may be 20° C. or less, 15° C. or less, 10° C. or less, 5° C. or less, 0° C. or less, −5° C. or less, or −10° C. or less.

The Tg of the soft phase of the polymer may be calculated by the Flory-Fox equation, shown below, wherein Tg is the glass transition temperature, Tg,∞ is the maximum glass transition temperature that can be achieved at a theoretical infinite molecular weight, Mₙ is the number average molecular weight of the polymer, and K is an empirical parameter related to the free volume present in the polymer sample.

$${T}_{g} = {T}_{g , ∞} - K / {M}_{n}$$

The acrylate component of the styrene/acrylic latex or acrylic latex can be derived from one or more soft ethylenically-unsaturated monomers. As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 20° C. or less. Soft ethylenically-unsaturated monomers are known in the art, and include, for example, methyl acrylate (Tg=10° C.), ethyl acrylate (Tg=−24° C.), n-butyl acrylate, (Tg=−54° C.), sec-butyl acrylate (Tg=−26° C.), n-hexyl acrylate (Tg=−45° C.), n-hexyl methacrylate (Tg=−5° C.), 2-ethylhexyl acrylate (Tg=−85° C.), 2-ethylhexyl methacrylate (Tg=−10° C.), octyl methacrylate (Tg=−20° C.), n-decyl methacrylate (Tg=−30° C.), isodecyl acrylate (Tg=−55° C.), dodecyl acrylate (Tg=−3° C.), dodecyl methacrylate (Tg=−65° C.), 2-ethoxyethyl acrylate (Tg=−50° C.), 2-methoxy acrylate (Tg=−50° C.), and 2-(2-ethoxyethoxy)ethyl acrylate (Tg=−70° C.).

In some embodiments, soft phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less). In certain embodiments, the soft ethylenically-unsaturated monomer can be a (meth)acrylate monomer. In certain embodiments, the acrylate component of the styrene/acrylic latex or acrylic latex can be derived from a soft ethylenically-unsaturated monomer selected from the group consisting of n-butyl acrylate, ethyl acrylate, sec-butyl acrylate, 2-ethylhexyl (meth)acrylate, and combinations thereof.

In some embodiments, soft phase can include a hard ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less). Hard ethylenically-unsaturated monomers are known in the art, and include, for example, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, soft phase can include a soft ethylenically-unsaturated monomer and a hard ethylenically-unsaturated monomer that, when copolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

The styrene/acrylic latex or acrylic latex can be derived from at least 10% to at most 95% by weight of one or more soft ethylenically-unsaturated monomers, based on the total weight of the monomers used to form the styrene/acrylic latex or acrylic latex (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, or at least 90% by weight). The styrene/acrylic latex or acrylic latex can be derived from at most 95% by weight of one or more soft ethylenically-unsaturated monomers, based on the total weight of the monomers used to form the styrene/acrylic latex or acrylic latex (e.g., at most 90% by weight, at most 80% by weight at most 80% by weight, at most 75% by weight, at most 70% by weight, at most 65% by weight, at most 60% by weight, at most 55% by weight, at most 50% by weight, at most 45% by weight, at most 40% by weight, at most 35% by weight, at most 30% by weight, at most 25% by weight, at most 20% by weight, or at most 15% by weight).

The styrene/acrylic latex or acrylic latex can be derived from an amount of one or more soft ethylenically-unsaturated monomers ranging from any of the minimum percentages described above to any of the maximum percentages described above. For example, the styrene/acrylic latex or acrylic latex can be derived from 15% to 95% by weight of one or more soft ethylenically-unsaturated monomers, based on the total weight of the monomers used to form the styrene/acrylic latex or acrylic latex (e.g., from 15% to 85% by weight, from 25% to 80% by weight, from 30% to 70% by weight, or from 35% to 55% by weight). Preferably, the styrene/acrylic latex or acrylic latex can be derived from about 40% to about 95% by weight of one or more soft ethylenically-unsaturated monomers, based on the total weight of the monomers used to form the styrene/acrylic latex or acrylic latex.

Optionally, the styrene/acrylic latex or acrylic latex may contain a hard phase. The hard phase of the styrene/acrylic latex or acrylic latex may have a glass transition temperature (Tg), as calculated by the Flory-Fox equation, higher than the Tg of the soft phase. The Tg of the hard phase of the styrene/acrylic latex or acrylic latex may be 20° C. higher than that of the soft phase, for example.

The hard phase can include one or more hard ethylenically-unsaturated monomers. As used herein, the term “hard ethylenically-unsaturated monomer” refers to an ethylenically-unsaturated monomer that, when homopolymerized, forms a polymer having a Tg, as measured using DSC, of greater than 20° C. Hard ethylenically-unsaturated monomers are known in the art, and include, for example, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, hard phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

In some embodiments, hard phase can include a soft ethylenically-unsaturated monomer and a hard ethylenically-unsaturated monomer that, when copolymerized, forms a polymer having a glass transition temperature higher than the Tg of the soft phase. The Tg of the hard phase of the styrene/acrylic latex or acrylic latex may be 20° C. higher than that of the soft phase, for example.

In some embodiments, the styrene/acrylic latex or acrylic latex can be derived from greater than 5% by weight of one or more hard ethylenically-unsaturated monomers (e.g., 10% by weight or greater, 20% by weight or greater, 30% by weight or greater, 40% by weight or greater, 50% by weight or greater, 55% by weight or greater of the hard ethylenically-unsaturated monomer) based on the total weight of monomers used to form the styrene/acrylic latex or acrylic latex.

In some embodiments, the styrene/acrylic latex or acrylic latex can be derived from less than 60% by weight of one or more hard ethylenically-unsaturated monomers (e.g., 55% or less by weight, 50% or less by weight, 45% or less by weight, 40% or less by weight, 35% or less by weight, 30% or less by weight, 25% or less by weight, 20% or less by weight, 15% or less by weight, 10% or less by weight) based on the total weight of monomers used to form the styrene/acrylic latex or acrylic latex.

The styrene/acrylic latex or acrylic latex can be derived from one or more additional ethylenically-unsaturated monomers (e.g., (meth)acrylate monomers, vinyl aromatic monomers, etc.) as described below in addition to one or more soft ethylenically-unsaturated monomers, one or more phosphorus-containing monomers, and one or more acetoacetoxy monomers, keto or aldehyde monomers.

The styrene/acrylic latex or acrylic latex can be derived from greater than 0% by weight to 55% by weight of one or more additional ethylenically-unsaturated monomers. Additional ethylenically unsaturated monomers include (meth)acrylate monomers. These meth(acrylate) monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofirfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof. In some embodiments, the acrylate component of the styrene/acrylic latex or acrylic latex comprises one or more (meth)acrylate monomers selected from the group consisting of methyl methacrylate, n-butyl acrylate, 2-ethylhexylacrylate, and combinations thereof. In some embodiments, the acrylate component of the styrene/acrylic latex or acrylic latex comprises methyl methacrylate and n-butyl acrylate.

In the styrene/acrylic latex or acrylic latex, additional ethylenically unsaturated monomers may include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth)acrylamide, adhesion promoting ureido functional (meth)acrylate monomer, a (meth)acrylamide derivative, a sulfur-based monomer, or a combination of these monomers.

Suitable vinyl aromatic compounds include styrene, α- and p-methylstyrene, α-butylstyrene, 4-n-butylstyrene, 4-n-decylstyrene, vinyltoluene, and combinations thereof. Vinyl esters of carboxylic acids with alkanols having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Alkoxy silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylalkoxysilanes, such as (meth)acryloyloxypropyltrimethoxysilane, γ-(meth)acryloxypropyltrimethoxysilane, and γ-(meth)acryloxypropyltriethoxysilane. Sulfur-containing monomers include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. When present, the sulfur-containing monomers are generally present in an amount greater than 0% by weight to 5% by weight.

The styrene/acrylic latex or acrylic latex may include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The styrene/acrylic latex or acrylic latex can be derived from one or more phosphorous acid-containing monomers based on the total weight of monomers. Ammonium, alkali metal ion, alkaline earth metal ion and other metal ion salts of these acids can also be used. Suitable phosphorus-containing monomers are vinylphosphonic acid and allylphosphonic acid, for example. Also suitable are the monoesters and diesters of phosphonic acid and phosphoric acid with hydroxyalkyl(meth)acrylates, especially the monoesters. Additionally suitable monomers are diesters of phosphonic acid and phosphoric acid that have been esterified once with hydroxyalkyl(meth)acrylate and also once with a different alcohol, such as an alkanol, for example. Suitable hydroxyalkyl(meth)acrylates for these esters are those specified below as separate monomers, more particularly 2-hydroxyethyl(meth)acrylate, 3-hydroxypropyl(meth)acrylate, 4-hydroxybutyl(meth)acrylate, etc. Corresponding dihydrogen phosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide or propylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Of further suitability are phosphoalkyl crotonates, phosphoalkyl maleates, phosphoalkyl fumarates, phosphodialkyl(meth)acrylates, phosphodialkyl crotonates and allyl phosphates.

Examples of phosphate containing unsaturated monomers are Sipomer® PAM 4000 or Sipomer® PAM 200, distributed, by, for example, Solvay. Alkali or alkaline earth metal ion or ammonia neutralized salts of the above acids and combinations thereof can also be used. In some instances, the monomer mixture can include a mixture of ethylenically unsaturated acids, for instance (meth)acrylic acid and phosphorous acid containing monomers, or itaconic acid and phosphorous acid containing monomers or combination of carboxylic and phosphorous acid containing monomers. Alkali or alkaline earth metal ion or ammonia neutralized salts of the above acids and combinations thereof can also be used.

The styrene/acrylic latex or acrylic latex can be derived from greater than 0% by weight of one or more phosphorus-containing monomers, based on the total weight of the monomers used to form the styrene/acrylic latex or acrylic latex (e.g., at least 0.25% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight or at least 5% by weight or at least 10% by weight). The styrene/acrylic latex or acrylic latex can be derived from 10% or less by weight of one or more phosphorus-containing monomers, based on the total weight of the monomers used to form the styrene/acrylic latex or acrylic latex (e.g., from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight, or from 0.25% or less by weight).

The styrene/acrylic latex or acrylic latex can be derived from greater than 0% by weight of one or more acid-containing monomers, based on the total weight of the monomers used to form the styrene/acrylic latex or acrylic latex (e.g., at least 0.5% by weight, at least 1% by weight, at least 2% by weight, at least 3% by weight, at least 4% by weight, at least 5% by weight, at least 6% by weight, at least 7% by weight, at least 8% by weight, at least 9% by weight at least 10% by weight, at least 15% by weight, at least 20% by weight, at least 25% by weight, at least 30% by weight). The styrene/acrylic latex or acrylic latex can be derived from 30% or less by weight of one or more acid-containing monomers, based on the total weight of the monomers used to form the second copolymer (e.g., from 25% or less by weight, from 20% or less by weight, from 15% or less by weight, from 10% or less by weight, from 5% or less by weight, from 3% or less by weight, or from 1% or less by weight). Preferably, the styrene/acrylic latex or acrylic latex can be derived from about 0.5% to about 10% by weight of one or more acid-containing monomers, based on the total weight of the monomers used to form styrene/acrylic latex or acrylic latex.

The styrene/acrylic latex or acrylic latex can be derived from one or more carboxylic acid-containing monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The styrene/acrylic latex or acrylic latex can be derived from an amount of one or more acid-containing monomers ranging from any of the minimum percentages described above to any of the maximum percentages described above. For example, the styrene/acrylic latex or acrylic latex can be derived from greater than 0.5% by weight to 30% by weight of one or more acid-containing monomers, based on the total weight of the monomers used to form the styrene/acrylic latex or acrylic latex (e.g., from greater than 2% by weight to 20% by weight of one or more acid-containing monomers). In certain embodiments, the styrene/acrylic latex or acrylic latex is derived from greater than 2% by weight to 30% by weight (e.g., greater than 2% by weight to 10% by weight, greater than 2% by weight to 15% by weight, or greater than 2% by weight to 20% by weight) acid monomers.

The styrene/acrylic latex or acrylic latex can be derived from one or more sulfur acid-containing monomers. Suitable sulfur acid monomers are vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid and their ionic salts with ammonium and metal ions. Suitable styrenesulfonic acids and derivatives thereof are styrene-4-sulfonic acid and styrene-3-sulfonic acid, and their ionic salt with metal ions, such as sodium styrene-3-sulfonate and sodium styrene-4-sulfonate.

The styrene/acrylic latex or acrylic latex can be derived from an amount of one or more phosphorus-containing monomers ranging from any of the minimum percentages described above to any of the maximum percentages described above. For example, the styrene/acrylic latex or acrylic latex can be derived from greater than 0% by weight to 10% by weight of one or more phosphorus-containing monomers, based on the total weight of the monomers used to form the styrene/acrylic latex or acrylic latex (e.g., from greater than 0% by weight to 5% by weight of one or more phosphorus-containing monomers or from greater than 0% by weight to 2.5% by weight of one or more phosphorus-containing monomers). In certain embodiments, the styrene/acrylic latex or acrylic latex is derived from greater than 0% by weight to 10% by weight (e.g., greater than 0% by weight to 5% by weight, greater than 0% by weight to 3% by weight, greater than 0% by weight to 2.5% by weight, or greater than 0% by weight to 1.5% by weight) 2-phosphoethyl methacrylate (PEM).

The styrene/acrylic latex or acrylic latex may further comprise one or more cross-linkable monomers, such as acrylamide monomers, methacrylate monomers, acetoacetoxy monomers, ketone monomers, aldehyde monomers, silane monomers, and combinations thereof. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below

CH₂═CR¹C(O)NR²C(O)R³

wherein R¹ is hydrogen or methyl; R² is hydrogen, a C₁-C₄ alkyl group, or a phenyl group; and R³ is hydrogen, a C₁-C₄ alkyl group, or a phenyl group. For example, the (meth)acrylamide derivative can be diacetone acrylamide (DAAM) or diacetone methacrylamide. Suitable aldehyde monomers include (meth)acrolein.

The styrene/acrylic latex or acrylic latex can be derived from greater than 0% by weight of one or more acetoacetoxy, keto or aldehyde monomers, based on the total weight of the monomers used to form the styrene/acrylic latex or acrylic latex (e.g., at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, at least 9.5% by weight, at least 10% by weight or at least 15% by weight). The styrene/acrylic latex or acrylic latex can be derived from 15% or less by weight of one or more acetoacetoxy, keto or aldehyde monomers, based on the total weight of the monomers used to form the styrene/acrylic latex or acrylic latex (e.g., from 10% or less by weight, from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Acetoacetoxy, keto or aldehyde groups can be reacted with polyamines to form crosslinks. Polyamines with primary amine groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and Dytek. In some embodiments amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments, amines include Dytek A, Dytek EP, Dytek HMD, Dytek BHMT, and Dytek DCH-99. In some embodiments, amines are polyhydrazides derived from alipahtic and aromatic polycarboxylic acids including adipic dihydrazide, succinic dihydrazide, citric trihydrazide, isophthalic dihydrazide, phthalic dihydrazide, or trimellitic trihydrazide. Other amines include diethylenetriamine, triethylenetetramine, tetraethylenepentamine, pentaethylenehexamine, hexaethyleneheptamine, heptaethyleneoctamine, 5 octaethylenenonamine, higher polyimines e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine. The preferred amines are polyhydrazides or adipic acid dihydrazide when diacetone acrylamide and its derivative monomer are used.

The acetoacetoxy, keto or aldehyde group to primary amine group ratio varies between 10:1 equivalents to 1:1.2 equivalents (e.g., 9:1 equivalents to 1:1.1 equivalents, 8:1 equivalents to 1:1 equivalents, 7:1 equivalents to 1:1 equivalents, 6:1 equivalents to 1:1 equivalents, 5:1 equivalents to 1:1 equivalents).

The styrene/acrylic latex or acrylic latex can be derived from an amount of one or more acetoacetoxy, keto or aldehyde monomers ranging from any of the minimum percentages described above to any of the maximum percentages described above. For example, the styrene/acrylic latex or acrylic latex can be derived from greater than 0% by weight to 10% by weight of one or more acetoacetoxy, keto or aldehyde monomers, based on the total weight of the monomers used to form the styrene/acrylic latex or acrylic latex (e.g., from 0.25% by weight to 10% by weight of one or more acetoacetoxy, keto or aldehyde monomers, from 0.5% by weight to 5% by weight of one or more acetoacetoxy, keto or aldehyde monomers, from 1% by weight to 7.5% by weight of one or more acetoacetoxy, keto or aldehyde monomers, from 2.5% by weight to 7.5% by weight of one or more acetoacetoxy, keto or aldehyde monomers, or from 5% by weight to 7.5% by weight of one or more acetoacetoxy, keto or aldehyde monomers). In certain embodiments, the styrene/acrylic latex or acrylic latex is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the styrene/acrylic latex or acrylic latex is derived from greater than 0% by weight to 10% by weight (e.g., from 0.25% by weight to 10% by weight, from 0.5% by weight to 5% by weight, from 1% by weight to 7.5% by weight, from 2.5% by weight to 7.5% by weight, or from 5% by weight to 7.5% by weight) of diacetone acrylamide (DAAM).

The molecular weight of the styrene/acrylic latex or acrylic latex may be described by its number average molecular weight (M_{w}). Weight average molecular weight may be determined using static light scattering, for example, and may be calculated as shown below, wherein N, is the number of molecules of molecular mass Mᵢ:

$${M}_{w} = {\sum }_{i} {N}_{i} {M}_{i}^{2} / {\sum }_{i} {N}_{i} {M}_{i}$$

The styrene/acrylic latex or acrylic latex described herein have a weight average molecular weight Mw of 20,000 Daltons or greater (e.g., 20,000 Daltons or greater, 30,000 Daltons or greater, 40,000 Daltons or greater, 50,000 Daltons or greater, 60,000 Daltons or greater, or 70,000 Daltons or greater, 80,000 Daltons or greater, 90,000 Daltons or greater, or 100,000 Daltons or greater).

The styrene/acrylic latex or acrylic latex described herein may have a gel content from about 0% to about 100%. The gel content of the styrene/acrylic latex or acrylic latex may be measured by dissolving the dry polymer in tetrahydrofuran (THF) and measuring the insoluble content. The ratio of the insoluble content to the total dry polymer may then be determined.

The styrene/acrylic latex or acrylic latex may have a gel content greater than 50% (e.g, 50% or greater, 60% or greater, 70% or greater, 80% or greater, 90% or greater, or 100%).

### Rubber Latex

The at least one rubber latex can be a natural rubber latex or a synthetic rubber latex.

The synthetic rubber latex can be derived from vinyl aromatic monomers. Suitable vinyl aromatic compounds include styrene, α- and p-methylstyrene, α-butylstyrene, 4-n-butylstyrene, 4-n-decylstyrene, vinyltoluene, and combinations thereof.

The synthetic rubber latex can be derived from ethylenically unsaturated aliphatic monomers. Suitable ethylenically unsaturated aliphatic monomers include 1,3-butadiene, isoprene, 2-chlorobutadiene, and 2-propenenitrile (acrylonitrile), ethylene, propylene, and combinations thereof.

The synthetic rubber latex can include polymers derived from one species of monomer, such as acrylic, silicone, polyisoprene (derived from isoprene monomers) and chloroprene (derived from 2-chlorobutadiene). The rubber latex can include copolymers derived from more than one species of monomer, such as styrene-butadiene (derived from styrene and 1,3-butadiene monomers) and nitrile rubber (derived from 1,3-butadiene and 2-propenenitrile).

The glass transition temperature (Tg) of the rubber polymer can range from −50° C. to −10° C. For example, the Tg may be −50° C. or greater, −45° C. or greater, −40° C. or greater, −35° C. or greater, −30° C. or less, −25° C. or less, −20° C. or less, −15° C. or less, or −10° C. or less. The glass transition temperature can be determined by differential scanning calorimetry (DSC) by measuring the midpoint temperature using ASTM D 3418-12e1.

The Tg of the rubber polymer can be between any of the values described above. For example, the Tg can range from −50° C. to −10° C. (e.g., from −40° C. to −20° C., from −35° C. to −10° C., from −45° C. to −30° C., or from −15° C. to −10° C.).

The solid mass ratio of the styrene/acrylic latex or acrylic latex to the rubber latex can be between 90:10 and 10:90, such as 90:10, 80:20, 70:30, 60:40, 50:50, 40:60, 30:70, 20:80, and 10:90. Preferably, the weight ratio of the styrene/acrylic latex or acrylic latex to the rubber latex is between 70:30 and 50:50. Still more preferably, the weight ratio of the styrene/acrylic latex or acrylic latex to the rubber polymer is between 65:35 and 55:45. The weight ratio of the styrene/acrylic latex or acrylic latex to the rubber latex can range from any of the minimum values to any of the maximum values described above, based on the solid mass ratio of styrene/acrylic latex or acrylic latex to rubber polymer. For example, the weight ratio of the styrene/acrylic latex or acrylic latex to rubber polymer can be from 60:40 to 30:70.

Also provided are aqueous compositions comprising one or more of the latex blends described above. The aqueous compositions can further include one or more additives, including pigments, fillers, dispersants, coalescents, pH modifying agents, plasticizers, defoamers, surfactants, thickeners, biocides, co-solvents, and combinations thereof. The choice of additives in the composition will be influenced by a number of factors, including the nature of the multistage polymers (or multilayer particles) dispersed in the aqueous composition, as well as the intended use of the composition. In some cases, the composition can be, for example, a coating composition, such as a paint, a primer, or a paint-and-primer-in-one formulation. In some embodiments, the composition comprises less than or equal to 50 grams per liter of volatile organic compounds.

Examples of suitable pigments include metal oxides, such as titanium dioxide, zinc oxide, iron oxide, zinc sulfide, or combinations thereof. In certain embodiments, the composition includes a titanium dioxide pigment. Examples of commercially titanium dioxide pigments are KRONOS® 2101, KRONOS® 2310, KRONOS® 4311, available from Kronos WorldWide, Inc. (Cranbury, N.J.), TI-PURE® R-900, TI-PURE® R-746. TI-PURE® R-706, available from DuPont (Wilmington, Del.), or TIONA® AT1 commercially available from Millenium Inorganic Chemicals.

Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, tale (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Dispex® AA 4144, commercially available from BASF SE.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Examples of suitable pH modifying agents include amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Defoamers serve to minimize frothing during mixing and/or application of the coating composition. Suitable defoamers include mineral oil and silicone oil defoamers. Exemplary mineral oil-based defoamers are available as Foamaster® series from BASF Corp. Exemplary silicone-based defoamers such as polysiloxanes, polydimethylsiloxanes, polyether modified polysiloxanes, and combinations are available as FoamStar® series from BASF Corp.,

Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units; ethylene oxide derivatives of long chain carboxylic acids; analogous ethylene oxide condensates of long chain alcohols, and combinations thereof. Exemplary anionic surfactans include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyl and-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers may include ethylene glycol, propylene glycol, diethylene glycol, and combinations thereof.

Other suitable additives that can optionally be incorporated into the composition include rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, odorants, oils, waxes and slip aids, soil repellants, stain resisting agents, and combinations thereof.

Also provided are methods of making the latex polymer blends described above. The styrene/acrylic latex or acrylic latex including polymer blends described above can be prepared by heterophase polymerization techniques, including, for example, free-radical emulsion polymerization, suspension polymerization, and mini-emulsion polymerization. In some examples, the multistage polymer is prepared by polymerizing the monomers using free-radical emulsion polymerization. The emulsion polymerization temperature can range from 10° C. to 130° C. (e.g., from 50° C. to 90° C.). The polymerization medium can include water alone or a mixture of water and water-miscible liquids, such as methanol, ethanol or tetrahydrofuran. In some embodiments, the polymerization medium is free of organic solvents and includes only water.

The emulsion polymerization can be carried out as a batch process, as a semi-batch process, or in the form of a continuous process. In some embodiments, a portion of the monomers can be heated to the polymerization temperature and partially polymerized, and the remainder of the monomer batch can be subsequently fed to the polymerization zone continuously, in steps, or with superposition of a concentration gradient. In some embodiments, the method of making a styrene/acrylic latex or acrylic latex comprises:
(i) polymerizing one or more of a soft ethylenically unsaturated monomer, a hard ethylenically unsaturated monomer or a mixture of a soft ethylenically unsaturated monomer and a hard ethylenically unsaturated monomer, one or more phosphorus-containing monomers, an acetoacetoxy or keto monomer and additional ethylenically unsaturated monomers in a first emulsion polymerization step to produce a styrenelacrylic latex or acrylic latex having a first theoretical Tg; and
(ii) polymerizing one or more of a soft ethylenically unsaturated monomer, a hard ethylenically unsaturated monomer or a mixture of a soft ethylenically unsaturated monomer and a hard ethylenically unsaturated monomer, one or more acid group containing monomers, an acetoacetoxy or keto monomer and additional ethylenically unsaturated monomers in a second emulsion polymerization step to produce a second copolymer having a second theoretical Tg.
(iii) then adding polyfunctional amines that crosslink with acetoacetate or keto monomers in first and second copolymer.

In some embodiments, the first polymerization step and/or the second copolymerization step are carried out at a first polymerization temperature ranging from 10° C. to 130° C. (e.g., from 50° C. to 100° C., or from 70° C. to 90° C.). In one embodiment, the first polymerization step and the second copolymerization step are carried out at polymerization temperatures of less than or equal to 95° C.

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 2% or 0.5% to 1% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethyl esters, mercaptoethanol, mercaptopropyltrimethoxysilane, and tert-dodecyl mercaptan. Additionally, it is possible to use regulators without a thiol group, such as terpinolene. In some embodiments, the styrene/acrylic latex or acrylic latex is prepared in the presence of greater than 0% to 0.5% by weight, based on the monomer amount, of at least one molecular weight regulator. In some embodiments, the styrene/acrylic latex or acrylic latex is prepared in the presence of less than less than 0.3% or less than 0.2% by weight (e.g., 0.10% to 0.15% by weight) of the molecular weight regulator.

Surfactants can also be added during polymerization to help maintain the dispersion of the monomers in the aqueous medium. For example, the polymerization can include less than 3% by weight or less than 1% by weight of surfactants. In some embodiments, the polymerization is substantially free of surfactants and can include less than 0.05% or less than 0.01% by weight of one or more surfactants.

Anionic and nonionic surfactants can be used during polymerization. Suitable surfactants include ethoxylated C₈ to C₃₆ or C₁₂ to C₁₈ fatty alcohols having a degree of ethoxylation of 3 to 50 or of 4 to 30, ethoxylated mono-, di-, and tri-C₄ to C₁₂ or C₄ to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids.

In some embodiments, the method of making a styrene/acrylic latex or acrylic latex comprises:
i) preparing a styrenelacrylic latex or acrylic latex selected from the group consisting of pure acrylics, styrene acrylics, vinyl acrylics, acrylated ethylene vinyl acetate copolymers, and mixtures thereof, and optionally a crosslinking monomer selected from diacetone acrylamide (DAAM) or acetoacetoxyethyl methacrylate (AAEM) by emulsion polymerization; and
ii) combining the styrene/acrylic latex or acrylic latex with a rubber latex, to form an aqueous composition, wherein the solid mass ratio of styrene/acrylic latex or acrylic latex to rubber polymer is between 90:10 and 10:90, preferably between 80:20 and 20:80, still more preferably between 70:30 and 50:50, and most preferably 65:35 and 55:45, based on the solid mass ratio of styrene/acrylic latex or acrylic latex to rubber polymer.

The styrene/acrylic latex or acrylic latex formed in step ii above may then be crosslinked with adipic dihydrazide, a multifunctional amine, or a metal ion.

Also provided are coatings and films formed from the coating compositions described herein. Generally, coatings are formed by applying a coating composition described herein to a surface, and allowing the coating to dry to form a coating. The coating thickness can vary depending upon the application of the coating. A film formed from the coating may be removable or peelable.

The coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating compositions can be applied to a variety of surfaces including, but not limited to metal, asphalt, concrete, stone, ceramic, wood, plastic, polyurethane foam, glass, wall board coverings (e.g., drywall, cement board, etc.), and combinations thereof. The coating compositions can be applied to interior or exterior surfaces. In certain embodiments, the surface is an architectural surface, such as a roof, dry wall, floor, wood, plastic, or combination thereof. The architectural surface can be located above ground, below ground, or combinations thereof.

As described further below, the coatings, or films, of the latex polymer blends provided herein can have low tackiness, good film strength, and display low adhesion to substrates.

Dried film specimens were tested according to a modified ASTM D412 method. Dried film specimens were cut into dog-bone shaped specimens, having a width of 0.15±0.01 inches and a gauge length of 1±0.01 inches. The dry film thickness ranges from 0.05 mm to 0.5 mm. Elongation at break was measured in triplicate using Instron. Deformation was applied at 1 inch per minute until sample film ruptured.

The film strength may be described by its elongation at break by controllably deforming the film in the axial direction. Dried film specimens were cut into dog-bone shaped specimens, having a width of 0.15±0.01 inches and a gauge length of 1±0.01 inches. Elongation at break was measured in triplicate using Instron® model number 3382. Deformation was applied at 1 inch per minute until sample film ruptured.

Films derived from the latex blends described herein may have an elongation at break greater than the film derived from the polymer emulsion without blending with rubber latex. The elongation at break improvement is greater than 30% strain unit or greater. For examples, films derived from the latex blends described herein may have an elongation at break of 200% or greater (e.g., 200% or greater, 210% or greater, 220% or greater, 230% or greater, 240% or greater, 250% or greater, 260% or greater, or 270% or greater).

By way of non-limiting illustration, examples of certain embodiments of the present disclosure are given below.

### EXAMPLES

The following examples are for the purpose of illustration of the invention only and are not intended to limit the scope of the present invention in any manner whatsoever.

### Example 1: Synthesis of Styrene Latex

A styrene latex is synthesized via emulsion polymerization using a mixture of monomers comprising styrene, 2-ethylhexyl acrylate, methacrylic acid, and diacetone acrylamide. Adipic dihydrazide (ADDH) is added to the latex following completion of emulsion polymerization to provide a styrene/acrylic latex. The styrene/acrylic latex has a glass transition temperature (Tg) of about −40° C. and a gel content of greater than 95%.

The styrene/acrylic latex may then blended with a styrene butadiene rubber latex with a Tg of about −53° C. The solid polymer weight ratio of styrene acrylic polymer to styrene butadiene polymer may be about 60:40.

### Example 2: Film Strength

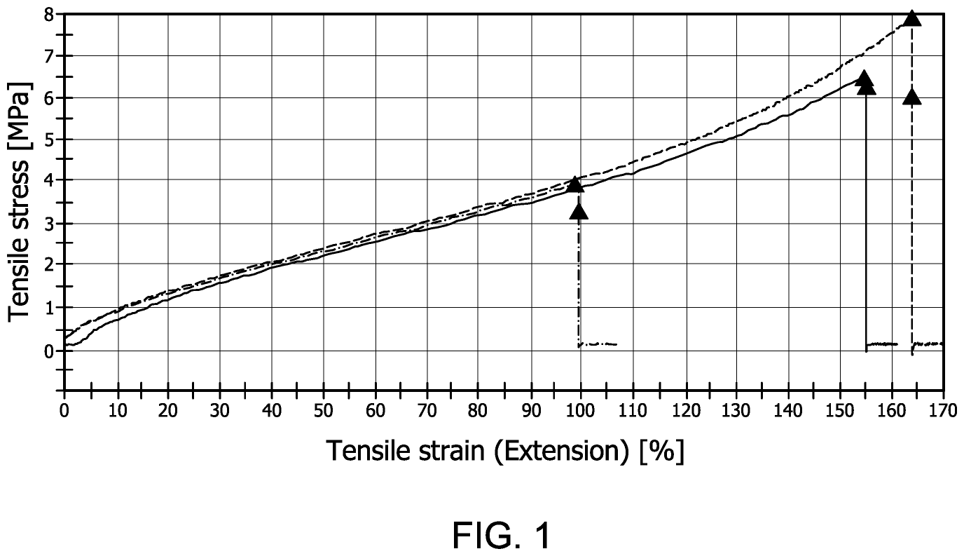

A dry film formed using the styrene/acrylic latex described in Example 1 is a low-tack film; however, it is fragile and breaks easily. One method by which film strength may be measured is through a tensile elongation test. As shown in FIG. 1, a styrene acrylic dry film not blended with a rubber polymer was tested for tensile elongation. The mean value for strain at the point of breakage was approximately 140%.

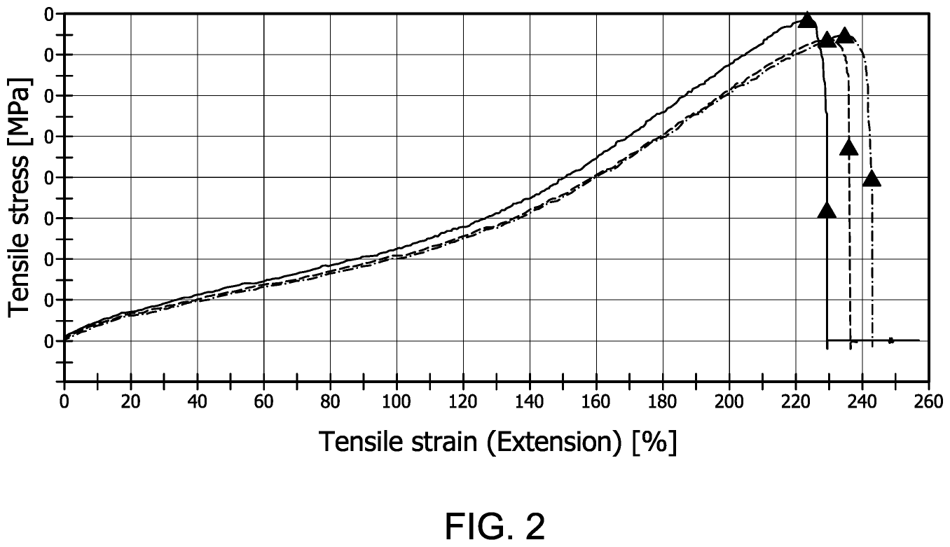

A dry film comprising a blend of styrene/acrylic latex with styrene butadiene rubber latex as described in Example 1 was tested in a tensile elongation test. The mean value for strain at the point of breakage for this film was approximately 240%, as shown in FIG. 2.

It was found that the blend described in Example 1 is particularly suitable for coating applications in which low tackiness and good film strength is desired, such as peelable or strippable coatings. The dry film formed using the latex blend described in Example 1 showed very low surface tack, low adhesion to substrates, and may be peeled off.

### Example 3: Coating Morphology

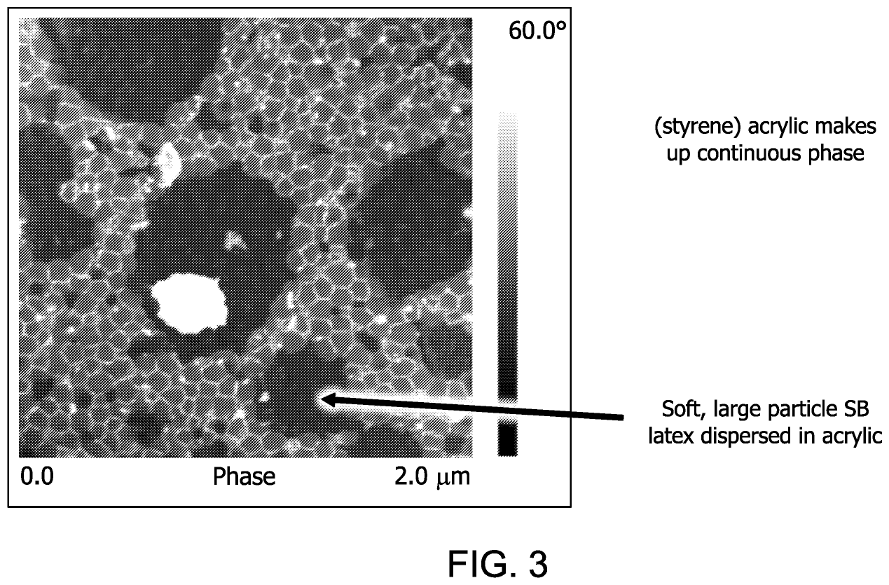

The dry film of the latex blend described in Example 1 may have a heterogeneous morphology, as shown as FIG. 3. The styrene acrylic polymer may form a continuous domain in the dry film, and the rubber polymer particles from the rubber latex may form a discrete phase structure; in other words, the rubber particles may appear as droplets in the continuous domain as shown in under atomic force microscopy (AFM) in FIG. 3. Without wishing to be bound by theory, it is believed that the rubber droplet domain contributes to toughening the polymer matrix, resulting in a tougher polymer film.

### Embodiments

Embodiment 1. A latex blend comprising: at least one at least one styrene/acrylic latex or acrylic latex selected from the group consisting of pure acrylics, styrene acrylics, vinyl acrylics, acrylated ethylene vinyl acetate copolymers, and mixtures thereof; at least one rubber latex, wherein the solid mass ratio of styrene/acrylic latex or acrylic latex to rubber latex is between 90:10 and 10:90.

Embodiment 2. The latex blend of Embodiment 1, wherein the rubber latex has a Tg, measured using DSC, less than −20° C.

Embodiment 3. The latex blend of either Embodiment 1 or Embodiment 2, wherein the styrene/acrylic latex or acrylic latex contains a soft phase, and the Tg of the soft phase of the polymer, calculated by Flory-Fox equation, is less than 20° C.

Embodiment 4. The latex blend of any one of Embodiments 1 to 3, wherein the styrene/acrylic latex or acrylic latex contains a hard phase, and the Tg of the hard phase of the polymer, calculated by Flory-Fox equation, is 20° C. or more higher than the Tg of the soft phase.

Embodiment 5. The latex blend of any of Embodiments 1 to 4, wherein the styrene/acrylic latex or acrylic latex has a weight average molecular weight Mw of 20 k or higher.

Embodiment 6. The latex blend of any of Embodiments 1 to 5, wherein the styrene/acrylic latex or acrylic latex has a gel content greater than 50%, measured by dissolving dry polymer in tetrahydrofuran and measuring the insoluble content to total dry polymer ratio.

Embodiment 7. The latex blend of any of Embodiments 1 to 6, wherein the rubber latex is a styrene-butadiene latex, a natural rubber latex, or a synthetic rubber latex.

Embodiment 8. The latex blend of any of Embodiments 1 to 7, wherein the at least one styrene/acrylic latex or acrylic latex comprises at least one monomer selected from the group consisting of styrene, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid, and vinylphosphonic acid.

Embodiment 9. The latex blend of Embodiment 8, wherein the at least one styrene/acrylic latex or acrylic latex is derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, vinylphosphonic acid.

Embodiment 10. The latex blend of any of Embodiments 1 to 9, wherein the styrene/acrylic latex or acrylic latex further comprises a cross-linkable monomer.

Embodiment 11. The latex blend of Embodiment 8, wherein the styrene/acrylic latex or acrylic latex further comprises a crosslinking agent selected from the group consisting of adipic dihydrazide (ADDH), multifunctional amine, and a metal ion.

Embodiment 12. The latex blend of Embodiment 11, wherein the cross-linkable monomer is selected from the group consisting of acrylamide monomers, methacrylate monomers, acetoacetoxy monomers, ketone monomers, aldehyde monomers, silane monomers, and combinations thereof.

Embodiment 13. The latex blend of Embodiment 12, wherein the cross-linkable monomer is selected from the group consisting of diacetone acrylamide (DAAM), acetoacetoxyethyl methacrylate (AAEM), and silane monomers.

Embodiment 14. A coating composition comprising the latex blend of any of Embodiments 1 to 13.

Embodiment 15. The coating according to Embodiment 14, further comprising an inorganic pigment, a plasticizer, a surfactant, a pigment, a filler, or a rheology modifier.

Embodiment 16. The coating according to Embodiment 15, wherein the inorganic pigment is selected from the group consisting of titanium dioxide, zinc oxide, zinc sulfide, and mixtures thereof.

Embodiment 17. The coating according to Embodiment 16, wherein the filler is selected from the group consisting of clay, silicates, calcium carbonate, talc, barytes, and mixtures thereof.

Embodiment 18. The coating composition according to Embodiment 15, wherein the styrene/acrylic latex or acrylic latex is an acrylic or styrene/acrylic latex polymer.

Embodiment 19. A film or membrane comprising the latex blend of any of Embodiments 1 to 13.

Embodiment 20. The film according to Embodiment 19, which has an elongation at break of at least 30%.

Embodiment 21. A method of preparing an aqueous coating composition, comprising: i) preparing an styrene/acrylic latex or acrylic latex selected from the group consisting of pure acrylics, styrene acrylics, vinyl acrylics, acrylated ethylene vinyl acetate copolymers, and mixtures thereof, and optionally a crosslinking monomer selected from diacetone acrylamide (DAAM) or acetoacetoxyethyl methacrylate (AAEM) by emulsion polymerization; and ii) combining the styrene/acrylic latex or acrylic latex with a rubber latex, to form an aqueous composition, wherein the solid mass ratio of styrene/acrylic latex or acrylic latex to rubber polymer is between 90:10 and 10:90, based on the solid mass ratio of styrene/acrylic latex or acrylic latex to rubber polymer.

Embodiment 22. The method of Embodiment 21, further comprising crosslinking the aqueous composition formed in ii) with a cross-linking agent selected from the group consisting of adipic dihydrazide (ADDH), multifunctional amine, and a metal ion.

1.-22. (canceled)

23. A latex blend comprising:
at least one at least one styrene/acrylic latex or acrylic latex selected from the group consisting of pure acrylics, styrene acrylics, vinyl acrylics, acrylated ethylene vinyl acetate copolymers, and mixtures thereof,
at least one rubber latex,
wherein the solid mass ratio of styrene/acrylic latex or acrylic latex to rubber latex is between 90:10 and 10:90.

24. The latex blend of claim 23, wherein the rubber latex has a Tg, measured using DSC, less than −20° C.

25. The latex blend of claim 23, wherein the styrene/acrylic latex or acrylic latex contains a soft phase, and the Tg of the soft phase of the polymer, calculated by Flory-Fox equation, is less than 20° C.

26. The latex blend of claim 23, wherein the styrene/acrylic latex or acrylic latex contains a hard phase, and the Tg of the hard phase of the polymer, calculated by Flory-Fox equation, is 20° C. or more higher than the Tg of the soft phase.

27. The latex blend of claim 23, wherein the styrene/acrylic latex or acrylic latex has a weight average molecular weight Mw of 20 k or higher.

28. The latex blend of claim 23, wherein the styrene/acrylic latex or acrylic latex has a gel content greater than 50%, measured by dissolving dry polymer in tetrahydrofuran and measuring the insoluble content to total dry polymer ratio.

29. The latex blend of claim 23, wherein the rubber latex is a styrene-butadiene latex, a natural rubber latex, or a synthetic rubber latex.

30. The latex blend of claim 23, wherein the at least one styrene/acrylic latex or acrylic latex comprises at least one monomer selected from the group consisting of styrene, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid, and vinylphosphonic acid.

31. The latex blend of claim 30, wherein the at least one styrene/acrylic latex or acrylic latex is derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, vinylphosphonic acid.

32. The latex blend of claim 23, wherein the styrene/acrylic latex or acrylic latex further comprises a cross-linkable monomer.

33. The latex blend of claim 30, wherein the styrene/acrylic latex or acrylic latex further comprises a crosslinking agent selected from the group consisting of adipic dihydrazide (ADDH), multifunctional amine, and a metal ion.

34. The latex blend of claim 33, wherein the cross-linkable monomer is selected from the group consisting of acrylamide monomers, methacrylate monomers, acetoacetoxy monomers, ketone monomers, aldehyde monomers, silane monomers, and combinations thereof.

35. The latex blend of claim 34, wherein the cross-linkable monomer is selected from the group consisting of diacetone acrylamide (DAAM), acetoacetoxyethyl methacrylate (AAEM), and silane monomers.

36. A coating composition comprising the latex blend of claim 23.

37. The coating according to claim 36, further comprising an inorganic pigment, a plasticizer, a surfactant, a pigment, a filler, or a rheology modifier.

38. The coating according to claim 37, wherein the inorganic pigment is selected from the group consisting of titanium dioxide, zinc oxide, zinc sulfide, and mixtures thereof.

39. The coating according to claim 38, wherein the filler is selected from the group consisting of clay, silicates, calcium carbonate, talc, barytes, and mixtures thereof.

40. The coating composition according to claim 37, wherein the styrene/acrylic latex or acrylic latex is an acrylic or styrene/acrylic latex polymer.

41. A film or membrane comprising the latex blend of claim 23.

42. The film according to claim 41, which has an elongation at break of at least 30%.

43. A method of preparing an aqueous coating composition, comprising:
i) preparing an styrene/acrylic latex or acrylic latex selected from the group consisting of pure acrylics, styrene acrylics, vinyl acrylics, acrylated ethylene vinyl acetate copolymers, and mixtures thereof, and optionally a crosslinking monomer selected from diacetone acrylamide (DAAM) or acetoacetoxyethyl methacrylate (AAEM) by emulsion polymerization; and
ii) combining the styrene/acrylic latex or acrylic latex with a rubber latex, to form an aqueous composition, wherein the solid mass ratio of styrene/acrylic latex or acrylic latex to rubber polymer is between 90:10 and 10:90, based on the solid mass ratio of styrene/acrylic latex or acrylic latex to rubber polymer.

44. The method of claim 43, further comprising crosslinking the aqueous composition formed in ii) with a cross-linking agent selected from the group consisting of adipic dihydrazide (ADDH), multifunctional amine, and a metal ion.
